(19) United States
(12) Patent Application Publication
(10) Pub. No.: US 2025/0105342 A1
(43) Pub. Date: Mar. 27, 2025

(54) LITHIUM PHOSPHORUS OXYSULFIDE SOLID ELECTROLYTES FOR BATTERIES THAT CYCLE LITHIUM IONS AND METHODS OF MANUFACTURING THE SAME

(71) Applicant: GM GLOBAL TECHNOLOGY OPERATIONS LLC, Detroit, MI (US)

(72) Inventors: Yubin ZHANG, Madison Heights, MI (US); Thomas A. YERSAK, Royal Oak, MI (US); Hernando GONZALEZ MALABET, Livonia, MI (US)

(21) Appl. No.: 18/471,878

(22) Filed: Sep. 21, 2023

(51) Int. Cl. H01M 10/0562; C01B 25/30; H01M 4/62; H01M 10/0525

(52) U.S. Cl. CPC H01M 10/0562; C01B 25/30; H01M 4/62; H01M 10/0525; C01P 2002/72; C01P 2004/61; C01P 2006/40; H01M 2220/20; H01M 2300/0071

(57) ABSTRACT

A solid electrolyte for a battery that cycles lithium ions includes an electrically insulating and ionically conductive lithium phosphorus oxysulfide (LPSO) represented by the formula Li₃PSₓO_{y}, where x is greater than about 3.5 and less than or equal to about 3.8 and y is greater than or equal to about 0.2 and less than about 0.5. The LPSO solid electrolyte may be manufactured by annealing an amorphous precursor including lithium (Li), phosphorus (P), sulfur(S), and oxygen (O) at a temperature of greater than about 240 degrees Celsius and less than or equal to about 300 degrees Celsius for a duration of greater than about 1 hour and less than or equal to about 4 hours.

### GOVERNMENT FUNDING

This invention was made with Government support under Agreement No. DE-EE0008857 awarded by the U.S. Department of Energy. The Government may have certain rights in the invention.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to solid electrolytes for batteries that cycle lithium ions, and more particularly to lithium phosphorus oxysulfide (LPSO) solid electrolytes and methods of manufacturing the LPSO solid electrolytes.

Batteries that cycle lithium ions generally comprise a negative electrode, a positive electrode, and an electrolyte that provides a medium for the conduction of lithium ions between the negative and positive electrodes. The electrolyte may be entirely solid and referred to as a “solid-state electrolyte,” or the electrolyte may be a composite of a solid and a liquid and referred to as a “semi-solid-state electrolyte.”

### SUMMARY

A solid electrolyte for a battery that cycles lithium ions is disclosed. The electrolyte comprises an electrically insulating and ionically conductive lithium phosphorus oxysulfide (LPSO) represented by the formula Li₃PSₓO_{y}, where x is greater than or equal to about 3.7 and less than or equal to about 3.8 and y is greater than or equal to about 0.2 and less than or equal to about 0.3.

The LPSO may be primarily crystalline and may have a crystalline volume fraction of greater than or equal to about 90%.

The LPSO may have an ionic conductivity at a temperature of about 25 degrees Celsius of greater than or equal to about 1 millisiemens per centimeter.

The LPSO may be represented by the formula Li₃PSₓO_{y}, where x is about 3.75 and y is about 0.25.

A battery that cycles lithium ions is disclosed. The battery comprises a negative electrode comprising an electroactive negative electrode material, a positive electrode spaced apart from the negative electrode and comprising an electroactive positive electrode material, and an electrolyte disposed between the negative electrode and the positive electrode that provides a medium for the conduction of lithium ions between the negative electrode and the positive electrode. The electrolyte comprises an electrically insulating and ionically conductive lithium phosphorus oxysulfide (LPSO) represented by the formula Li₃PSₓO_{y}, where x is greater than about 3.5 and less than or equal to about 3.8 and y is greater than or equal to about 0.2 and less than about 0.5.

The LPSO may be represented by the formula Li₃PSₓO_{y}, where x is greater than or equal to about 3.7 and less than or equal to about 3.8 and y is greater than or equal to about 0.2 and less than or equal to about 0.3.

The LPSO may be primarily crystalline and may have a crystalline volume fraction of greater than or equal to about 90%.

The LPSO may have an ionic conductivity at a temperature of about 25 degrees Celsius of greater than or equal to about 1 millisiemens per centimeter.

The LPSO may be a particulate material comprising particles having a mean particle diameter of greater than or equal to about 1 micrometer and less than or equal to about 10 micrometers.

The electrolyte may further comprise a liquid electrolyte solution comprising a nonaqueous aprotic organic solvent and a lithium salt.

The LPSO may constitute, by weight, greater than or equal to about 10% and less than or equal to about 100% of the electrolyte.

At least one of the negative electrode or the positive electrode may further comprise particles of the LPSO.

A method of manufacturing a solid electrolyte for a battery that cycles lithium ions is disclosed. In the method, a precursor is prepared by mixing together starting materials comprising lithium (Li), phosphorus (P), sulfur(S), and oxygen (O). The starting materials comprise, on an atomic basis, about 37.5% Li, about 12.5% P, greater than about 43.75% and less than or equal to about 47.5% S, and greater than or equal to about 2.5% and less than about 6.25% O. The precursor is annealed in an inert gas environment at a temperature of greater than about 240 degrees Celsius and less than or equal to about 300 degrees Celsius for a duration of greater than about 1 hour and less than or equal to about 4 hours to form an electrically insulating and ionically conductive lithium phosphorus oxysulfide (LPSO) solid electrolyte.

The starting materials may comprise lithium sulfide (Li₂S), phosphorus pentasulfide (P₂S₅), and phosphorus pentoxide (P₂O₅). In such case, a molar ratio of the LizS, P₂S₅, and P₂O₅ (Li₂S:P₂S₅:P₂O₅) in the starting materials may be A:B:C, where A is about 75, B is greater than about 20 and less than or equal to about 23, and C is greater than or equal to about 2 and less than about 5.

The precursor may be prepared by mixing the starting materials together using a melt quenching process, a mechanical ball milling process, or a wet-chemical process.

Prior to annealing the precursor, the precursor may be substantially amorphous and may have a crystalline volume fraction of less than or equal to about 10%.

The precursor may be annealed at a temperature of about 260 degrees Celsius for a duration of greater than or equal to about 2 hours and less than or equal to about 3 hours.

The method may further comprise, after annealing, grinding the LPSO solid electrolyte to form particles of the LPSO solid electrolyte having a mean particle diameter of greater than or equal to about 1 micrometer and less than or equal to about 10 micrometers.

The LPSO solid electrolyte may be represented by the formula Li₃PSₓO_{y}, where x is greater than or equal to about 3.7 and less than or equal to about 3.8 and y is greater than or equal to about 0.2 and less than or equal to about 0.3.

The LPSO solid electrolyte may have a crystalline volume fraction of greater than or equal to about 90%.

The LPSO solid electrolyte may have an ionic conductivity at a temperature of about 25 degrees Celsius of greater than or equal to about 1 millisiemens per centimeter.

A lithium phosphorus oxysulfide (LPSO) solid electrolyte for a battery that cycles lithium ions may be manufactured by the methods described and claimed herein.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, and a solid electrolyte.

FIG. 4 depicts x-ray diffraction patterns (2θ degrees vs. Intensity (arbitrary units)) for lithium phosphorus oxysulfide (LPSO) solid electrolytes having different chemical compositions.

FIG. 5 depicts x-ray diffraction patterns (q(Å⁻¹) vs. Intensity (arbitrary units)) for LPSO solid electrolytes having different chemical compositions.

FIG. 6 depicts x-ray diffraction patterns (2θ degrees vs. Intensity (arbitrary units)) for LPSO solid electrolytes subjected to different annealing temperatures.

FIG. 7 depicts x-ray diffraction patterns (2θ degrees vs. Intensity (arbitrary units)) for LPSO solid electrolytes annealed at the same temperature for different durations.

In the drawings, reference numbers may be reused to identify similar and/or identical elements.

### DETAILED DESCRIPTION

The presently disclosed solid electrolytes are formulated for use in batteries that cycle lithium ions and comprise an electrically insulating and ionically conductive lithium phosphorus oxysulfide (LPSO) having high crystallinity and high ionic conductivity. The LPSO is manufactured by mixing together starting materials comprising lithium (Li), phosphorus (P), sulfur(S), and oxygen (O) to form a substantially amorphous precursor. Then, the substantially amorphous precursor is annealed within a certain temperature range and for a certain range of durations to form an LPSO solid electrolyte having a unique crystal structure with unexpectedly high ionic conductivity. The amorphous precursor is annealed at a relatively low temperature and for a relatively short duration, as compared to methods used to manufacture lithium phosphorus sulfide (LPS) solid electrolytes having a BLisPS4-type crystalline structure.

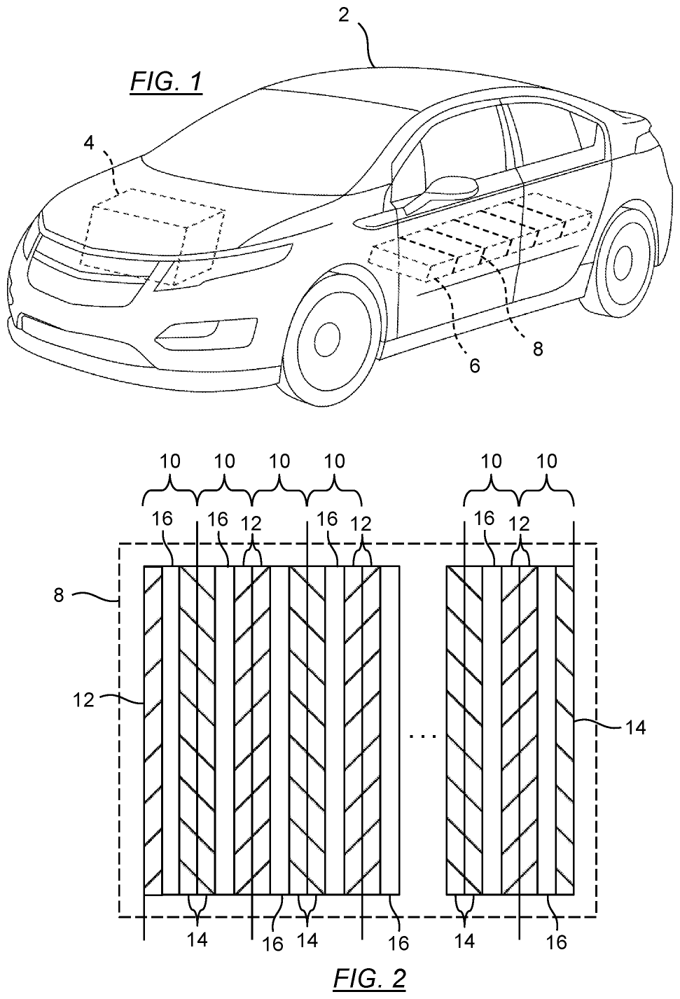

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative and positive electrode current collectors 13, 15 are double sided and include negative or positive electrode layers 12, 14 on both sides thereof. In this arrangement, adjacent negative electrode layers 12 and positive electrode layers 14 share a single negative or positive current collector 13, 15.

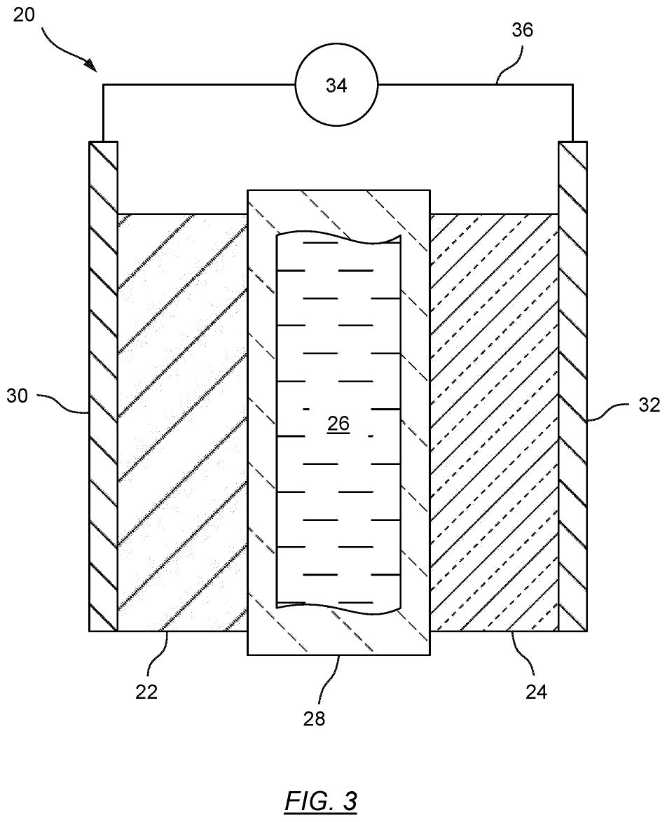

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, and an electrolyte 28 that provides a medium for the conduction of lithium ions between the negative electrode 22 and the positive electrode 24. The negative electrode 22 is disposed on a negative electrode current collector 30 and the positive electrode 24 is disposed on a positive electrode current collector 32. In practice, the negative electrode current collector 30 and the positive electrode current collector 32 are electrically coupled to a power source or load 34 (e.g., the electric motor 12) via an external circuit 36. The negative and positive electrodes 22, 24 are formulated such that, when the battery 20 is at least partially charged, an electrochemical potential difference is established between the negative and positive electrodes 22, 24. During discharge of the battery 20, the electrochemical potential established between the negative and positive electrodes 22, 24 drives spontaneous reduction and oxidation (redox) reactions within the battery 20 and the release of lithium ions and electrons at the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative and positive electrodes 22, 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The electrolyte 28 is ionically conductive and provides a medium for the conduction of lithium ions through the battery 20 between the negative and positive electrodes 22, 24. In embodiments, the electrolyte 28 may function as a separator and may physically separate and electrically isolate the negative and positive electrodes 22, 24 from each other while permitting lithium ions to pass therethrough. The electrolyte 28 comprises an electrically insulating and ionically conductive inorganic solid electrolyte material. In aspects, the electrolyte 28 may be entirely solid and referred to as a “solid-state electrolyte.” In embodiments where the electrolyte 28 is a solid-state electrolyte, the electrolyte 28 may consist essentially of or consist of the solid electrolyte material. In aspects, the electrolyte 28 may be a composite of a solid and a liquid and may be referred to as a “semi-solid-state electrolyte.” In embodiments where the electrolyte 28 is a semi-solid-state electrolyte, the electrolyte 28 may comprise the solid electrolyte material, a liquid electrolyte solution 26, and optionally a polymer matrix or a polymer film.

The solid electrolyte material of the electrolyte 28 comprises a lithium phosphorus oxysulfide (LPSO) represented by the formula (1):

Li₃PSₓO_{y}, (1)
where x is greater than about 3.5 and less than or equal to about 3.8, y is greater than or equal to about 0.2 and less than about 0.5, and x+y=about 4. For example, x may be about 3.5, about 3.55, about 3.6, about 3.65, about 3.7, about 3.75, or about 3.8 and y may be about 0.2, about 0.25, about 0.3, about 0.35, about 0.4, about 0.45, or about 0.5. In aspects, x may be greater than or equal to about 3.7 and less than or equal to about 3.8 and y may be greater than or equal to about 0.2 and less than or equal to about 0.3. In aspects, x is about 3.75 and y is about 0.25.

Additional elements not intentionally introduced into the composition of the LPSO of formula (1) nonetheless may be inherently present in the LPSO (or in the staring materials used to prepare the LPSO) in relatively small amounts, for example, less than 0.1%, preferably less than 0.05%, and more preferably less than 0.01% by weight of the LPSO (or of the staring materials used to prepare the LPSO). Such elements may be present, for example, as impurities in the staring materials used to prepare the LPSO.

The LPSO of formula (1) is primarily crystalline. For example, the LPSO may have a crystalline volume fraction of greater than or equal to about 50%, optionally greater than or equal to about 80%, optionally greater than or equal to about 90%, optionally greater than or equal to about 95%, optionally greater than or equal to about 98%, or optionally greater than or equal to about 99% and less than or equal to 100%.

The LPSO has an ionic conductivity at room temperature (e.g., about 25° C.) of greater than or equal to about 0.9 millisiemens per centimeter (mS/cm), optionally greater than or equal to about 0.95 mS/cm, optionally greater than or equal to about 1 mS/cm, optionally greater than or equal to about 1.05 mS/cm, optionally greater than or equal to about 1.1 mS/cm, or optionally greater than or equal to about 1.11 mS/cm.

The LPSO may constitute, by weight, greater than or equal to about 10%, optionally greater than or equal to about 20%, optionally greater than or equal to about 30%, optionally greater than or equal to about 40%, optionally greater than or equal to about 50%, optionally greater than or equal to about 60%, optionally greater than or equal to about 70%, optionally greater than or equal to about 80%, or optionally greater than or equal to about 90% and less than or equal to about 100% of the electrolyte 28.

The LPSO may be a particulate material and particles of the LPSO may be distributed substantially homogenously throughout the electrolyte 28. In such case, the LPSO particles may have a mean particle diameter of greater than or equal to about 1 micrometer (μm) and less than or equal to about 10 μm.

The solid electrolyte material of the electrolyte 28 optionally may comprise, in addition to the LPSO of formula (1), another electrically insulating and ionically conductive solid electrolyte material. Electrically insulating and ionically conductive solid electrolyte materials that may be included in the electrolyte 28 in combination with the LPSO of formula (1) include metal oxide-based materials, sulfide-based materials, nitride-based materials, hydride-based materials, halide-based materials, borate-based materials, and combinations thereof. Examples of metal oxide-based solid electrolyte materials include NASICON-type solid electrolyte materials (e.g., Li_{1.4}Al_{0.4}Ti_{1.6} (PO₄)₃), LISICON-type solid electrolyte materials (e.g., Li₂₊₂ₓZn₁₋ₓGeO₄), perovskite-type solid electrolyte materials (e.g., Li₃ₓLa_{2/3-x}TiO₃), garnet-type solid electrolyte materials (e.g., Li₇La₃Zr₂O₁₂), and/or metal-doped or aliovalent-substituted metal oxide-based solid electrolyte materials (e.g., Al- or Nb-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, and/or Al-substituted perovskite, Li_{1+x+y}AlₓTi₂₋ₓSi_{y}P_{3-y}O₁₂). Examples of sulfide-based solid electrolyte materials include argyrodite materials represented by the formula Li₆PS₅X, where X═Cl, Br, I; lithium phosphorus sulfide materials represented by one or more of the following formulas Li₃PS₄, Li_{9.6}P₃S₁₂, and/or Li₇P₃S₁₁; LGPS-type materials represented by the formula Li₁₁₋ₓM₂₋ₓP₁₊ₓS₁₂, where M=Ge, Sn, Si (e.g., Li₁₀GeP₂S₁₂, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, and/or Li₁₀(Si_{0.5}Sn_{0.5})P₂S₁₂); Li₂S—P₂S₅-type materials; Li₂S—P₂S₅-MOₓ-type materials; Li₂S—P₂S₅-MSₓ-type materials; thio-LISICON-type materials (e.g., Li_{3.25}Ge_{0.25}P_{0.75}S₄); Li_{3.4}Si_{0.4}P_{0.6}S₄; Li₁₀GeP₂S_{11.7}O_{0.3}; Li_{9.54}Si_{1.74}P_{1.44}S_{11.7}Cl_{0.3}; Li_{3.833}Sn_{0.833}AS0.166S₄; LiI—Li₄SnS₄; and/or Li₄SnS₄. Examples of nitride-based solid electrolyte materials include Li₃N, Li₇PN₄, and/or LiSi₂N₃. Examples of hydride-based solid electrolyte materials include LiBH₄, LiBH₄—LiX, where X═Cl, Br or I, LiNH₂, Li₂NH, LiBH₄-LINH₂, and/or Li₃AlH₆. Examples of halide-based solid electrolyte materials include: LiI, Li₃InCl₆, Li₂CdCl₄, Li₂MgCl₄, Li₂CdI₄, Li₂ZnI₄, and/or LisOCl. Examples of borate-based solid electrolyte materials include: Li₂B₄O₇ and/or Li₂O—B₂O₃—P₂O₅.

In embodiments where the electrolyte 28 is a semi-solid-state electrolyte, the electrolyte 28 may comprise a liquid electrolyte solution 26 comprising an organic solvent and a lithium salt in the organic solvent. The organic solvent may comprise a nonaqueous aprotic organic solvent. Examples of nonaqueous aprotic organic solvents include alkyl carbonates, for example, cyclic carbonates (e.g., ethylene carbonate (EC), propylene carbonate (PC), butylene carbonate (BC), fluoroethylene carbonate (FEC), vinylene carbonate (VC), glycerol carbonate (GC), and/or 1,2-Butylene carbonate) and/or linear carbonates (e.g., dimethyl carbonate (DMC), diethyl carbonate (DEC), and/or ethylmethylcarbonate (EMC)); aliphatic carboxylic esters (e.g., methyl formate, methyl acetate, and/or methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof. Examples of lithium salts include lithium bis(oxalato) borate, LiB(C2O4)2 (LiBOB); lithium tetracyanoborate, Li(B(CN4) (LiTCB); lithium tetrafluoroborate, LiBF4; lithium bis(monofluoromalonato) borate (LiBFMB); lithium trifluoromethanesulfonate, LiCF3SO3); lithium bis(fluorosulfonyl)imide, LiN(FSO2)2 (LiSFI); lithium cyclo-difluoromethane-1,1-bis(sulfonyl)imide (LiDMSI); lithium bis(trifluoromethane) sulfonylimide, LiN(CF3SO2)2; lithium bis(perfluoroethanesulfonyl)imide, LiN(C2F5SO2)2; lithium cyclo-hexafluoropropane-1,1-bis(sulfonyl)imide (LiHPSI); lithium difluoro (oxalato) borate (LiDFOB); lithium bis(trifluoromethanesulfonyl)imide (LiTFSI); and combinations thereof.

In embodiments where the electrolyte 28 is a semi-solid-state electrolyte, the electrolyte 28 optionally may comprise a polymer matrix, which may act as a host for the liquid electrolyte solution 26. The polymer matrix may comprise poly(ethylene oxide) (PEO), poly(acrylic acid) (PAA), poly(methyl methacrylate) (PMMA), carboxymethyl cellulose (CMC), polyacrylonitrile (PAN), polyvinylidene difluoride (PVDF), poly(vinyl alcohol) (PVA), polyvinylpyrrolidone (PVP), a copolymer of poly(vinylidene fluoride) and hexafluoropropylene, also referred to as poly(vinylidene fluoride-co-hexafluoropropylene) (PVDF-HFP), or a combination thereof.

In embodiments where the electrolyte 28 is a semi-solid-state electrolyte, the electrolyte 28 optionally may comprise a polymer film an open microporous structure, which may act as a host for the liquid electrolyte solution 26. The polymer film may comprise one or more polyolefins, e.g., polyethylene (PE), polypropylene (PP), polyamide (PA), poly(tetrafluoroethylene) (PTFE), polyvinylidene fluoride (PVdF), and/or poly(vinyl chloride) (PVC). In embodiments, the polymer film may comprise a laminate of polymers, e.g., a laminate of PE and PP.

The positive electrode 24 is formulated to reversibly store and release lithium ions during discharge and charge of the battery 20 and may be in the form of a continuous porous layer disposed on the major surface of the positive electrode current collector 32. The positive electrode 24 comprises an electrochemically active (electroactive) material (electroactive positive electrode material), a polymer binder, and optionally an electrically conductive material. In aspects, the electroactive material of the positive electrode 24 may be a particulate material and particles of the electroactive material of the positive electrode 24 may be intermingled with the polymer binder and the optional electrically conductive material.

The electroactive material of the positive electrode 24 can store and release lithium ions by undergoing a reversible redox reaction with lithium at a higher electrochemical potential than the electrochemically active material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a layered lithium transition metal oxide represented by the formula LiMeO₂, an olivine-type lithium transition metal oxide represented by the formula LiMePO₄, a monoclinic-type lithium transition metal oxide represented by the formula LisMe₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In aspects where the electroactive material of the positive electrode 24 comprises a conversion material, the electroactive material of the positive electrode 24 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof (e.g., a compound of iron, manganese, nickel, copper, and/or cobalt). The electroactive material of the positive electrode 24 may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the positive electrode 24.

The polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than or equal to about 1%, or optionally greater than or equal to about 5%, and less than or equal to about 10% of the positive electrode 24.

The optional electrically conductive material is electrochemically inactive and may be included in the positive electrode 24 to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to about 1%, or optionally greater than or equal to about 5% and less than or equal to about 10% of the positive electrode 24.

In embodiments, for example, where the electrolyte 28 is a solid-state electrolyte, the positive electrode 24 may further comprise an electrically insulating and ionically conductive solid electrolyte material. Examples of solid electrolyte materials that may be included in the positive electrode 24 include the LPSO of formula (1), as well as the other solid electrolyte materials described above with respect to the electrolyte 28. When included in the positive electrode 24, the solid electrolyte materials (e.g., the LPSO) may constitute, by weight, greater than 0%, optionally greater than or equal to about 10%, or optionally greater than or equal to about 15% and less than or equal to about 30%, or optionally less than or equal to about 20% of the positive electrode 24.

The negative electrode 22 is configured to store and release lithium ions during charge and discharge of the battery 20 and may be in the form of a continuous layer of material disposed on a major surface of the negative electrode current collector 30. The negative electrode 22 comprises an electrochemically active (electroactive) material (electroactive negative electrode material) that can store and release lithium ions by undergoing a reversible redox reaction with lithium during charge and discharge of the battery 20. Examples of electroactive materials for the negative electrode 22 include lithium, lithium-based materials, lithium alloys (e.g., alloys of lithium and silicon, aluminum, indium, tin, or a combination thereof), carbon-based materials (e.g., graphite, activated carbon, carbon black, hard carbon, soft carbon, and/or graphene), silicon, silicon-based materials (e.g., silicon oxide, alloys if silicon and tin, iron, aluminum, cobalt, or a combination thereof and/or composites of silicon and/or silicon oxide and carbon), tin oxide, aluminum, indium, zinc, germanium, silicon oxide, lithium silicon oxide, lithium silicide, titanium oxide, lithium titanate, and combinations thereof. The electroactive material of the negative electrode 22 may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the negative electrode 22.

In aspects, the electroactive material of the negative electrode 22 may consist of lithium and the negative electrode 22 may be in the form of a nonporous metal film or foil, such as a lithium metal film or lithium metal foil. In other aspects, the negative electrode 22 may be porous and the electroactive material of the negative electrode 22 may be a particulate material. In aspects where the electroactive material of the negative electrode 22 is a particulate material, particles of the electroactive material of the negative electrode 22 may be intermingled with a polymer binder and optionally an electrically conductive material. The same polymer binders and/or electrically conductive materials disclosed above with respect to the positive electrode 24 may be used in the negative electrode 22 in substantially the same amounts.

In embodiments, for example, where the electrolyte 28 is a solid-state electrolyte, the negative electrode 22 may further comprise an electrically insulating and ionically conductive solid electrolyte material. Examples of solid electrolyte materials that may be included in the negative electrode 22 include the LPSO of formula (1), as well as the other solid electrolyte materials described above with respect to the electrolyte 28. When included in the negative electrode 22, the solid electrolyte materials (e.g., the LPSO) may constitute, by weight, greater than 0%, optionally greater than or equal to about 10%, or optionally greater than or equal to about 15% and less than or equal to about 30%, or optionally less than or equal to about 20% of the negative electrode 22.

The positive and negative electrode current collectors 30, 32 are electrically conductive and provide an electrical connection between the external circuit 36 and their respective positive and negative electrodes 22, 24. In aspects, the positive and negative electrode current collectors 30, 32 may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

### Methods

The LPSO solid electrolyte of formula (1) may be manufactured by preparing an amorphous precursor comprising certain desirable amounts of lithium (Li), phosphorus (P), sulfur(S), and oxygen (O), and then annealing the amorphous precursor within a certain temperature range and for a certain duration.

The amorphous precursor may be prepared by mixing together starting materials comprising Li, P, S, and O. The respective amounts of Li, P, S, and O in the starting materials may be selected to achieve the respective amounts of Li, P, S, and O set forth in the LPSO solid electrolyte of formula (1). For example, the starting materials may comprise, on an atomic basis, about 37.5% Li, about 12.5% P, greater than about 43.75% and less than or equal to about 47.5% S, and greater than or equal to about 2.5% and less than about 6.25% O. In aspects, the S may constitute, on an atomic basis, greater than or equal to about 44%, optionally greater than or equal to about 44.5%, optionally greater than or equal to about 45%, or optionally greater than or equal to about 45.5% and less than or equal to about 47%, optionally less than or equal to about 46.5%, or optionally less than or equal to about 46% of the starting materials. In aspects, the O may constitute, on an atomic basis, greater than or equal to about 3%, optionally greater than or equal to about 3.5%, optionally greater than or equal to about 4%, or optionally greater than or equal to about 4.5% and less than or equal to about 6%, optionally less than or equal to about 5.5%, or optionally less than or equal to about 5% of the starting materials.

In aspects, the amorphous precursor may be prepared by mixing together starting materials of lithium sulfide (Li₂S), phosphorus pentasulfide (P₂S₅), and phosphorus pentoxide (P₂O₅). The respective amounts of Li₂S, P₂S₅, and P₂O₅ in the starting materials may be selected to achieve the respective amounts of lithium (Li), sulfur(S), phosphorus (P), and oxygen (O) set forth in the LPSO solid electrolyte of formula (1). For example, the molar ratio of the Li₂S, P₂S₅, and P₂O₅ (Li₂S:P₂S₅:P₂O₅) in the starting materials may be represented as A:B:C, where the molar proportion of Li₂S in the starting materials is represented by the term A, the molar proportion of P₂S₅ in the starting materials is represented by the term B, and the molar proportion of P₂O₅ in the starting materials is represented by the term C. In such case, the molar proportion of Li₂S (A) in the starting materials may be about 75, the molar proportion of P₂S₅ (B) in the starting materials may be greater than about 20 and less than or equal to about 23, and the molar proportion of P₂O₅ (C) in the starting materials may be greater than or equal to about 2 and less than about 5 (e.g., A:B:C=75:20-23:2-5). In aspects, B may be greater than or equal to about 21, optionally greater than or equal to about 22, optionally greater than or equal to about 22.1, optionally greater than or equal to about 22.2, optionally greater than or equal to about 22.3, or optionally greater than or equal to about 22.4 and less than or equal to about 22.9, optionally less than or equal to about 22.8, optionally less than or equal to about 22.7, or optionally less than or equal to about 22.6. In aspects, C may be greater than or equal to about 2.1, optionally greater than or equal to about 2.2, optionally greater than or equal to about 2.3, or optionally greater than or equal to about 2.4 and less than or equal to about 4, optionally less than or equal to about 3, optionally less than or equal to about 2.9, optionally less than or equal to about 2.8, optionally less than or equal to about 2.7, or optionally less than or equal to about 2.6. In aspects, A may be about 75, B may be greater than or equal to about 22 and less than or equal to about 23, and C may be greater than or equal to about 2 and less than or equal to about 3. In aspects, A may be about 75, B may be about 22.5, and C may be about 2.5.

In aspects, the amorphous precursor may be prepared by mixing the starting materials together using a melt quenching process, a mechanical ball milling process, or a wet-chemical process. For example, the amorphous precursor may be prepared by mechanically mixing the starting materials (e.g., the Li₂S, P₂S₅, and P₂O₅) together in an inert gas environment (e.g., argon) at room temperature (e.g., about 25° C.). The starting materials may be mixed together, for example, in a ball mill (e.g., a planetary ball mill) operating at a speed of about 500 revolutions per minute (rpm) for a duration of about 20 hours. In aspects, the amorphous precursor may be prepared using a wet mechanical mixing process and, in such case, the starting materials (e.g., the Li₂S, P₂S₅, and P₂O₅) may be mixed together in combination with a solvent. In aspects where the amorphous precursor is prepared using a wet mechanical mixing process, after the starting materials are mixed together the solvent may be removed therefrom, for example, by heating the amorphous precursor in an inert gas environment to evaporate the solvent therefrom.

The amorphous precursor is substantially amorphous and is substantially free of crystal grains. For example, the amorphous precursor may have a crystalline volume fraction of less than or equal to about 10%, optionally less than or equal to about 5%, optionally less than or equal to about 3%, or optionally less than or equal to about 1%.

The amorphous precursor is annealed in an inert gas environment to form the LPSO solid electrolyte of formula (1). The amorphous precursor may be annealed by heating the amorphous precursor at a temperature of greater than or equal to about 240° C., or optionally greater than or equal to about 250° C. and less than or equal to about 300° C., optionally less than or equal to about 290° C., optionally less than or equal to about 280° C., or optionally less than or equal to about 270° C. The amorphous precursor may be annealed by heating the amorphous precursor for a duration of greater than about 1 hour, optionally greater than or equal to about 1.5 hours, or optionally greater than or equal to about 2 hours and less than or equal to about 4 hours, optionally less than or equal to about 3.5 hours, optionally less than or equal to about 3 hours, or optionally less than or equal to about 2.5 hours. In aspects, the amorphous precursor may be annealed by heating the precursor mixture at a temperature of about 260° C. for a duration of about 2 hours.

After annealing, the LPSO solid electrolyte may be in the form of a particulate material having relatively coarse grains. For example, after annealing, the LPSO solid electrolyte may comprise particles having diameters of up to about 1 millimeter. After the annealing step, it may be desirable to reduce the particle diameter of the LPSO solid electrolyte particles and/or increase the uniformity of the LPSO solid electrolyte particles. As such, after annealing, the LPSO solid electrolyte particles may be subjected to a grinding process to produce LPSO solid electrolyte particles having a mean particle diameter of greater than or equal to about 1 μm and less than or equal to about 10 μm.

### Experimental

Precursor materials having different proportions of Li₂S, P₂S₅, and P₂O₅ were prepared in a laboratory environment and evaluated using x-ray crystallography and electrochemical impedance spectroscopy (EIS) implemented on cold-pressed powders. Table 1 sets forth the molar ratio of Li₂S:P₂S₅:P₂O₅ in the precursor materials and resulting chemical formulas, the measured ionic conductivities (mS/cm) of the precursor materials prior to annealing, and the measured ionic conductivities (mS/cm) of the LPSO materials formed by annealing the precursor materials at a temperature of 260° C. for 2 hours.

TABLE 1

| | | | | Ionic |
|---|---|---|---|---|
| | | | Ionic | Conductivity |
| | | | Conductivity | after |
| Sample | Molar Ratio | Chemical | of Precursor | Annealing |
| No: | Li₂S:P₂S₅:P₂O₅: | Formula: | (mS/cm) | (mS/cm) |
| 1 | 75:25:0 | Li₃PS₄ (LPS) | 0.442 | 0.314 |
| 2 | 75:24:1 | Li₃PS_{3.9}O_{0.1} | 0.178 | 0.66 |
| 3 | 75:23.5:1.5 | Li₃PS_{3.85}O_{0.15} | 0.177 | 0.66 |
| 4 | 75:23:2 | Li₃PS_{3.8}O_{0.2} | 0.179 | 0.845 |
| 5 | 75:22.5:2.5 | Li₃PS_{3.75}O_{0.25} | 0.269 | 1.119 |
| 6 | 75:20:5 | Li₃PS_{3.5}O_{0.5} | 0.151 | 0.411 |

As shown in Table 1, the ionic conductivities of LPSO solid electrolytes having the formula (1) and formed by the presently disclosed methods (i.e., Samples 4 and 5) are significantly higher than the ionic conductivities of lithium phosphorus oxysulfide (LPSO) materials formed from precursor materials having different proportions of Li₂S, P₂S₅, and P₂O₅ (i.e., Samples 1, 2, and 3). Notably, Sample 5 having a chemical formula of LisPS_{3.75}O_{0.25} had an unexpectedly high ionic conductivity, as compared to that of Samples 1, 2, 3, 4, and 6.

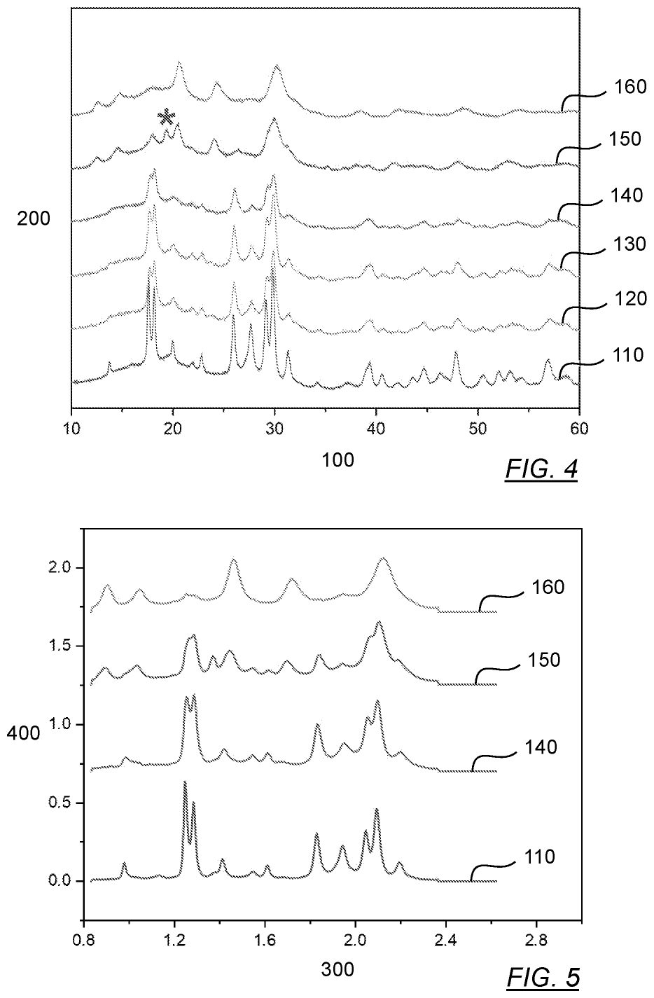

FIG. 4 depicts x-ray diffraction patterns (2θ degrees 100 vs. Intensity (arbitrary units) 200) for Samples 1 (110), 2 (120), 3 (130), 4 (140), 5 (150), and 6 (160) obtained using Cu Kα radiation (wavelength of 1.54 Å).

FIG. 5 depicts x-ray diffraction patterns (q(Å⁻¹) 300 vs. Intensity (arbitrary units) 400) for Samples 1 (110), 4 (140), 5 (150), and 6 (160) obtained via a wide-angle x-ray scattering (WAXS) technique using an ANL synchrotron (beamline 12-ID-B, 13.3 keV x-ray, q-range of 0.004 Å⁻¹ to about 2.7 Å⁻¹).

As shown in FIGS. 4 and 5, the crystal structures of LPSO solid electrolytes having the formula (1) and formed by the presently disclosed methods (i.e., Samples 4 and 5) are different from the crystal structures of lithium phosphorus oxysulfide (LPSO) materials formed from precursor materials having different proportions of Li₂S, P₂S₅, and P₂O₅ (i.e., Samples 1, 2, and 3).

Table 2 sets forth the measured ionic conductivities (mS/cm) of LPSO solid electrolyte samples having the formula Li₃PS_{3.75}O_{0.25} and annealed for 2 hours at different temperatures (240° C., 260° C., and 300° C.).

TABLE 2

| | | | | Ionic |
|---|---|---|---|---|
| | | | | Conductivity |
| | | | Annealing | after |
| Sample | Molar Ratio | Chemical | Temperature | Annealing |
| No: | Li₂S:P₂S₅:P₂O₅: | Formula: | (° C.) | (mS/cm) |
| 7 | 75:22.5:2.5 | Li₃PS_{3.75}O_{0.25} | 240 | 0.515 |
| 8 | 75:22.5:2.5 | Li₃PS_{3.75}O_{0.25} | 260 | 1.119 |
| 9 | 75:22.5:2.5 | Li₃PS_{3.75}O_{0.25} | 300 | 0.8 |

As shown in Table 2, the ionic conductivities of LPSO solid electrolytes having the formula Li₃PS_{3.75}O_{0.25} and formed by the presently disclosed methods (i.e., Samples 8 and 9) are significantly higher than the ionic conductivities of Sample 7. Notably, Sample 8 had an unexpectedly high ionic conductivity when annealed at a temperature of 260° C., as compared to that of Samples 7 and 9.

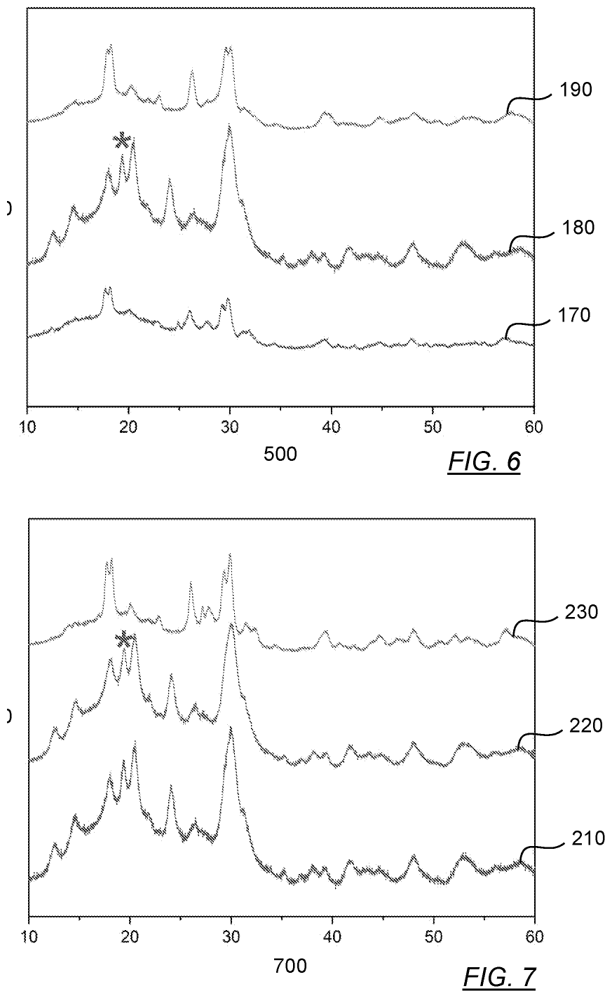

FIG. 6 depicts x-ray diffraction patterns (2θ degrees 500 vs. Intensity (arbitrary units) 600) for Samples 7 (170), 8 (180), and 9 (190) obtained using Cu Kα radiation. As shown in FIG. 6, the crystal structures of LPSO solid electrolytes having the formula Li₃PS_{3.75}O_{0.25} are different when subjected to different annealing temperatures.

Table 3 sets forth the measured ionic conductivities (mS/cm) of LPSO solid electrolyte samples having the formula Li₃PS_{3.75}O_{0.25} and annealed at 260° C. for different durations (1 hour, 2 hours, 4 hours, and 24 hours).

TABLE 3

| | | | | Ionic |
|---|---|---|---|---|
| | | | Annealing | Conductivity |
| Sample | Molar Ratio | Chemical | Duration | after Annealing |
| No: | Li₂S:P₂S₅:P₂O₅: | Formula: | (hours) | (mS/cm) |
| 10 | 75:22.5:2.5 | Li₃PS_{3.75}O_{0.25} | 1 | 0.545 |
| 11 | 75:22.5:2.5 | Li₃PS_{3.75}O_{0.25} | 2 | 1.119 |
| 12 | 75:22.5:2.5 | Li₃PS_{3.75}O_{0.25} | 4 | 0.639 |
| 13 | 75:22.5:2.5 | Li₃PS_{3.75}O_{0.25} | 24 | 0.561 |

As shown in Table 3, the ionic conductivities of LPSO solid electrolytes having the formula Li₃PS_{3.75}O_{0.25} and formed by the presently disclosed methods (i.e., Samples 11 and 12) are significantly higher than the ionic conductivities of Samples 10 and 13. Notably, Sample 11 had an unexpectedly high ionic conductivity when annealed at a temperature of 260° C. for 2 hours, as compared to that of Samples 10, 12, and 13.

FIG. 7 depicts x-ray diffraction patterns (2θ degrees 700 vs. Intensity (arbitrary units) 800) for Samples 11 (210), 12 (220), and 13 (230) obtained using Cu Kα radiation. As shown in FIG. 7, the crystal structures of LPSO solid electrolytes having the formula Li₃PS_{3.75}O_{0.25} are different when annealed at a temperature of 260° C. for different durations.

Without intending to be bound by theory, it is believed that, when LPSO solid electrolytes having the formula (1) are annealed within a certain temperature range (i.e., >240° C. and ≤300° C.) and for a certain duration (i.e., >1 hour and ≤4 hours), a LPSO solid electrolyte is formed with a unique crystal structure that provides the LPSO solid electrolyte with unexpectedly high ionic conductivity. In addition, it is believed that the unique crystal structure formed by the presently disclosed methods (i.e., when the LPSO solid electrolyte is annealed within the specific temperature range within the specific duration) is stable and retained after the LPSO solid electrolyte is cooled to room temperature.

Notably, the crystal structure of LPSO solid electrolytes manufactured by the presently disclosed methods is different from that of lithium phosphorus sulfide (LPS) solid electrolytes having a βLi₃PS₄-type crystalline structure. In addition, the ionic conductivities of LPSO solid electrolytes manufactured by the presently disclosed methods are significantly higher than that of LPS solid electrolytes having a βLi₃PS₄-type crystalline structure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A solid electrolyte for a battery that cycles lithium ions, the electrolyte comprising:
an electrically insulating and ionically conductive lithium phosphorus oxysulfide (LPSO) represented by the formula Li₃PSₓO_{y}, where x is greater than or equal to about 3.7 and less than or equal to about 3.8 and y is greater than or equal to about 0.2 and less than or equal to about 0.3.

2. The solid electrolyte of claim 1, wherein the LPSO is primarily crystalline and has a crystalline volume fraction of greater than or equal to about 90%.

3. The solid electrolyte of claim 1, wherein the LPSO has an ionic conductivity at a temperature of about 25 degrees Celsius of greater than or equal to about 1 millisiemens per centimeter.

4. The solid electrolyte of claim 1, wherein the LPSO is represented by the formula Li₃PSₓO_{y}, where x is about 3.75 and y is about 0.25.

5. A battery that cycles lithium ions, the battery comprising:
a negative electrode comprising an electroactive negative electrode material;
a positive electrode spaced apart from the negative electrode and comprising an electroactive positive electrode material; and
an electrolyte disposed between the negative electrode and the positive electrode that provides a medium for the conduction of lithium ions between the negative electrode and the positive electrode, the electrolyte comprising an electrically insulating and ionically conductive lithium phosphorus oxysulfide (LPSO) represented by the formula Li₃PSₓO_{y}, where x is greater than about 3.5 and less than or equal to about 3.8 and y is greater than or equal to about 0.2 and less than about 0.5.

6. The battery of claim 5, wherein the LPSO is represented by the formula Li₃PSₓO_{y}, where x is greater than or equal to about 3.7 and less than or equal to about 3.8 and y is greater than or equal to about 0.2 and less than or equal to about 0.3.

7. The battery of claim 5, wherein the LPSO is primarily crystalline and has a crystalline volume fraction of greater than or equal to about 90%.

8. The battery of claim 5, wherein the LPSO has an ionic conductivity at a temperature of about 25 degrees Celsius of greater than or equal to about 1 millisiemens per centimeter.

9. The battery of claim 5, wherein the LPSO is a particulate material comprising particles having a mean particle diameter of greater than or equal to about 1 micrometer and less than or equal to about 10 micrometers.

10. The battery of claim 5, wherein the electrolyte further comprises a liquid electrolyte solution comprising a nonaqueous aprotic organic solvent and a lithium salt.

11. The battery of claim 5, wherein the LPSO constitutes, by weight, greater than or equal to about 10% and less than or equal to about 100% of the electrolyte.

12. The battery of claim 5, wherein at least one of the negative electrode or the positive electrode further comprises particles of the LPSO.

13. A method of manufacturing a solid electrolyte for a battery that cycles lithium ions, the method comprising:
preparing a precursor by mixing together starting materials comprising lithium (Li), phosphorus (P), sulfur(S), and oxygen (O), wherein the starting materials comprise, on an atomic basis, about 37.5% Li, about 12.5% P, greater than about 43.75% and less than or equal to about 47.5% S, and greater than or equal to about 2.5% and less than about 6.25% O; and
annealing the precursor in an inert gas environment at a temperature of greater than about 240 degrees Celsius and less than or equal to about 300 degrees Celsius for a duration of greater than about 1 hour and less than or equal to about 4 hours to form an electrically insulating and ionically conductive lithium phosphorus oxysulfide (LPSO) solid electrolyte.

14. The method of claim 13, wherein the starting materials comprise lithium sulfide (Li₂S), phosphorus pentasulfide (P₂S₅), and phosphorus pentoxide (P₂O₅), and wherein a molar ratio of the Li₂S, P₂S₅, and P₂O₅ (Li₂S:P₂S₅:P₂O₅) in the starting materials is A:B:C and A is about 75, B is greater than about 20 and less than or equal to about 23, and C is greater than or equal to about 2 and less than about 5.

15. The method of claim 13, wherein the precursor is prepared by mixing the starting materials together using a melt quenching process, a mechanical ball milling process, or a wet-chemical process.

16. The method of claim 13, wherein, prior to annealing the precursor, the precursor is substantially amorphous and has a crystalline volume fraction of less than or equal to about 10%.

17. The method of claim 13, wherein the precursor is annealed at a temperature of about 260 degrees Celsius for a duration of greater than or equal to about 2 hours and less than or equal to about 3 hours.

18. The method of claim 13, further comprising, after annealing, grinding the LPSO solid electrolyte to form particles of the LPSO solid electrolyte having a mean particle diameter of greater than or equal to about 1 micrometer and less than or equal to about 10 micrometers.

19. The method of claim 13, wherein the LPSO solid electrolyte is represented by the formula Li₃PSₓO_{y}, where x is greater than or equal to about 3.7 and less than or equal to about 3.8 and y is greater than or equal to about 0.2 and less than or equal to about 0.3, wherein the LPSO solid electrolyte has a crystalline volume fraction of greater than or equal to about 90%, and wherein the LPSO solid electrolyte has an ionic conductivity at a temperature of about 25 degrees Celsius of greater than or equal to about 1 millisiemens per centimeter.

20. A lithium phosphorus oxysulfide (LPSO) solid electrolyte for a battery that cycles lithium ions manufactured by the method of claim 13.
